(19) United States
(12) Patent Application Publication
(10) Pub. No.: US 2019/0155710 A1
(43) Pub. Date: May 23, 2019

(54) METHOD AND SERVER FOR TESTING A SYSTEM NETWORK

(71) Applicant: ROBERT BOSCH GMBH, Stuttgart (DE)

(72) Inventor: Juergen HORNUNG, Remshalden (DE)

(73) Assignee: Robert Bosch GmbH, Stuttgart (DE)

(21) Appl. No.: 16/091,234

(22) PCT Filed: Feb. 15, 2017
(86) PCT No.: PCT/EP2017/053390

§ 371 Date: Nov. 2, 2018

(30) Foreign Application Priority Data
Apr. 4, 2016 (DE) 10 2016 205 511.9

(51) Int. Cl. G06F 11/26; G07C 5/08; G07C 5/00; G06F 9/455

(52) U.S. Cl. CPC G06F 11/261; G06F 9/455; G07C 5/008; G07C 5/0808

(57) ABSTRACT

A method for testing a system network made up of a server, a connecting line, and a vehicle that is connected via the connecting line to the server, and having the following features in which: a diagnosis query of the vehicle is received on the server via the connecting line; based on the diagnosis query, a diagnostic service of the vehicle is emulated on the server; and a diagnosis response of the diagnostic service to the diagnosis query is transmitted from the server via the connecting line to the vehicle.

### FIELD OF THE INVENTION

The present invention relates to a method for testing a system network, which is made up of a server, a connecting line, and a vehicle connected to the server via the connecting line. In addition, the present invention relates to a corresponding server, a corresponding computer program as well as to a corresponding storage medium.

### BACKGROUND INFORMATION

In automotive engineering, and especially in automotive electronics, a vehicle diagnosis—taking its cue from the medical term ‘diagnosis’—denotes an allocation of findings to faults in electric or electronic components of vehicles. This collective term may thus be applied to a multitude of technical methods and to applications for a fault analysis in case of repairs, for statistical evaluations within the framework of quality assurance, and in the vehicle development. In addition to the on-board diagnostics for information purposes and in particular for warning the driver of looming faults and also for initiating suitable countermeasures, the ‘vehicle diagnosis’ in the narrower sense denotes the communication between an external test device, also known as a diagnosis tester, and the control units installed in the vehicle in accordance with a diagnosis protocol (off-board diagnostics).

A diagnostics module for the vehicle diagnosis from patent document WO 2014 202269 A1 has a communications unit, which is set up to transmit data to the control unit of a motor vehicle; a diagnostics unit, which is set up to perform a diagnosis of the motor vehicle on the basis of diagnostic data transmitted by the communications unit; and a transmission unit, which is set up to transmit diagnostic data from the diagnostics module to a server. The transmit unit is set up to transmit the diagnostic data via a mobile radio network and/or the Internet from the diagnostics module to the server.

### SUMMARY OF THE INVENTION

The present invention provides a method for testing a system network made up of a server, a connecting line, and a vehicle which is connected to the server via the connecting line; it also provides a corresponding server, a corresponding computer program, as well as a corresponding storage medium as recited in the independent claims.

The approach according to the present invention is based on the understanding that the related art does offer test systems from a variety of manufacturers for different individual components, but not in the system network. However, in the future, the diagnosis of networked vehicles could pose a similar challenge as that in the telephony field or with Internet connections. As a result, there will be functions that are exclusively the task of the vehicle itself, as in the case of conventional vehicles. In addition, however, there may also be functions that rely on the connecting line of the vehicle to a back end or to another vehicle or that assume that server components are operating correctly.

The present invention therefore recognizes that test systems for the indicated separate fields are presently already in existence. However, an overall view in a service workshop is able to be obtained only with difficulty.

One corresponding advantage of the solution proposed here is its suitability for testing functions that are “networked” via servers or between vehicles. According to the present invention, no fundamental change in the current diagnosis infrastructure is required for this purpose. Instead, existing diagnostic systems and the processes and authoring guidelines established for preparing relevant content descriptions are able to be retained.

The measures indicated in the dependent claims allow for advantageous further developments of and improvements in the basic concept indicated in the independent claim.

Exemplary embodiments of the present invention are shown in the drawing and described in greater detail in the following description.

### BRIEF DESCRIPTION OF THE DRAWINGS

FIG. 1 shows the flow diagram of a method according to a first specific embodiment.

FIG. 2 schematically shows a system network made up of a server according to a second specific embodiment, a connecting line, and a vehicle which is connected to the server via the connecting line.

### DETAILED DESCRIPTION

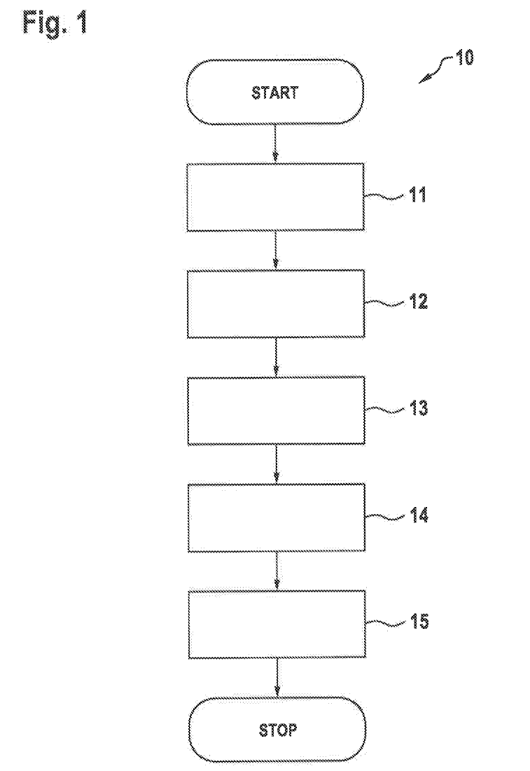

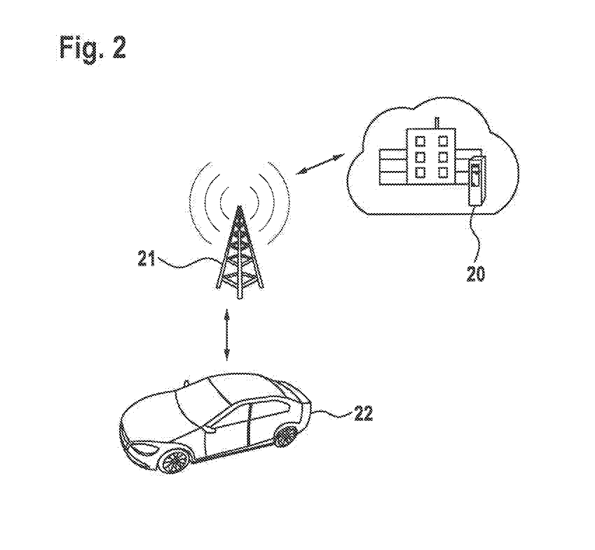

FIG. 1 illustrates the basic sequence of a method (10) according to the present invention in a system network (20, 21, 22) which is made up of a server (20), a connecting line (21), and a vehicle (22) which is connected to the server (20) via the connecting line (21). This method (10), for example, may be implemented in software or hardware or in a mixed form of software and hardware, e.g. on the server (20) serving as a back end, as illustrated by the schematic representation of FIG. 2.

Accordingly, a conventional diagnosis tester connected to the vehicle (22) first reads in (process 11) a formal description of the data to be exchanged within the framework of the vehicle or the control-unit diagnosis. A suitable standard for this purpose is known to one skilled in the art as an open diagnostic data exchange (OXD) according to ASAM MCD-2D and is standardized by ISO 22901-1.

Knowledge of the data structures to be used now enables the diagnosis tester to formulate (process 12) in the application layer a diagnosis query, which corresponds to the communications protocol for unified diagnostic services (USD) according to ISO 14229-1. Such a diagnosis query, for example, may be used for querying the operativeness of a control unit or for triggering the transmission of data.

A diagnosis query set up in this manner may now be posed to the server (20) via the connecting line (21). An Internet protocol stack (diagnostics over Internet protocol (DoIP)) according to ISO 13400-2 is used for the transport. In the network layer, the diagnosis query is not directed to a real control unit in the vehicle (22) in the usual manner, but to the mentioned server (20) itself, which after receiving (process 13) the diagnosis query, thus emulates (process 14) the corresponding diagnostic service of the vehicle (22) in the function of a virtual control unit, so to speak.

In this way, it is possible to formulate, largely independently of the vehicle (22), a diagnosis response to the diagnosis query on the server (20), which is then transmitted (process 15) via the connecting line (21) to the vehicle (22) and its diagnosis tester while utilizing the aforementioned protocols. Based on the received diagnosis response, the diagnosis tester finally checks whether the requested data are being received in the vehicle (22) or whether the function specified in the diagnosis query is triggered in the vehicle (22).

1-10. (canceled)

11. A method for testing a system network having a server, a connecting line, and a vehicle that is connected via the connecting line to the server, using a diagnosis tester, the method comprising:
connecting the diagnosis tester to the vehicle;
formulating a diagnosis query using the diagnosis tester, the diagnosis query being addressed to the server via the connecting line;
emulating a diagnosis service of the vehicle on the server;
transmitting a diagnosis response of the diagnostic service to the diagnosis query to the vehicle via the connecting line; and
checking the diagnosis response using the diagnosis tester.

12. The method of claim 11, wherein the diagnosis tester checks whether the requested data arrived in the vehicle and/or whether the function specified in the diagnosis query is triggered in the vehicle.

13. The method of claim 11, wherein the diagnostic service is a unified diagnostic service.

14. The method of claim 11, wherein the diagnosis query and the diagnosis response are transported in accordance with an Internet protocol via the connecting line.

15. The method of claim 11, wherein the diagnosis query and the diagnosis response comply with a predefined format.

16. The method of claim 15, wherein the format is described in an open diagnostic data exchange.

17. A non-transitory computer readable medium having a computer program, which is executable by a processor, comprising:
a program code arrangement having program code for testing a system network having a server, a connecting line, and a vehicle that is connected via the connecting line to the server, using a diagnosis tester, by performing the following:
connecting the diagnosis tester to the vehicle;
formulating a diagnosis query using the diagnosis tester, the diagnosis query being addressed to the server via the connecting line;
emulating a diagnosis service of the vehicle on the server;
transmitting a diagnosis response of the diagnostic service to the diagnosis query to the vehicle via the connecting line; and
checking the diagnosis response using the diagnosis tester.

18. The computer readable medium of claim 17, wherein the diagnosis tester checks whether the requested data arrived in the vehicle and/or whether the function specified in the diagnosis query is triggered in the vehicle.

19. A diagnosis tester, comprising:
a diagnostic testing unit, for testing a system network having a server, a connecting line, and a vehicle that is connected via the connecting line to the server, configured to perform the following:
connecting the diagnosis tester to the vehicle;
formulating a diagnosis query using the diagnosis tester, the diagnosis query being addressed to the server via the connecting line;
emulating a diagnosis service of the vehicle on the server;
transmitting a diagnosis response of the diagnostic service to the diagnosis query to the vehicle via the connecting line; and
checking the diagnosis response using the diagnosis tester.
